(19) United States
(12) Patent Application Publication
(10) Pub. No.: US 2003/0072887 A1
(43) Pub. Date: Apr. 17, 2003

(54) Method for coating a layer of transparent paint on surface of titanium substrate

(76) Inventors: Huei-Hsin Sun, Taipei City (TW); Ling-Yun Chou, Fengshan City (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/981,770

(22) Filed: Oct. 17, 2001

(51) Int. Cl. B05D 3/02; B05D 1/36

(52) U.S. Cl. 427/407.1; 427/409; 427/388.1

(57) ABSTRACT

A method of forming a coated titanium substrate comprises forming a titanium or titanium alloy based substrate, cleaning a surface of titanium substrate, coating an organic or inorganic solution on the surface of titanium substrate by plating, spraying, or rolling for forming a strong adhesion between titanium substrate and organic or inorganic solution, baking titanium substrate at a range from about 100° C. to about 230° C., and coating a layer of transparent paint on the surface of titanium substrate. This can form a strong adhesion between titanium substrate and transparent paint while demonstrating a unique surface property of titanium substrate.

### FIELD OF THE INVENTION

The present invention relates to surface coating and more particularly to a method for coating a layer of transparent paint on surface of titanium substrate with improved adhesion characteristics.

### BACKGROUND OF THE INVENTION

A conventional technique for coating a layer of transparent paint on surface of titanium substrate comprises cleaning surface of titanium substrate with hydrochloric acid for etching the surface of titanium substrate in order to form one that is adapted to adhere a subsequent applied transparent paint. However, the effect of such cleaning by hydrochloric acid is not significant since titanium substrate has an acid resistant property.

Another conventional technique for coating a layer of transparent paint on surface of titanium substrate comprises coating a base layer of paint on surface of titanium substrate, curing the base layer of paint, and printing a predetermined pattern on the cured base layer of paint. It is advantageous for being capable of displaying the predetermined pattern. However, the bright property of the surface of titanium substrate is not demonstrated. Thus improvement exists.

### SUMMARY OF THE INVENTION

It is therefore an object of the present invention to provide a method of forming a coated titanium substrate comprising (a) forming a titanium or titanium alloy based substrate; (b) cleaning a surface of the titanium substrate; (c) uniformly coating an organic or inorganic solution on the surface of the titanium substrate by plating, spraying, or rolling for forming a strong adhesion between the titanium substrate and the organic or the inorganic solution; (d) baking the titanium substrate coated with the organic or the inorganic solution at a temperature in a range from about 100° C. to about 230° C.; and (e) uniformly coating a layer of transparent paint on the surface of the titanium substrate.

The above and other objects, features and advantages of the present invention will become apparent from the following detailed description taken with the accompanying drawings.

### BRIEF DESCRIPTION OF THE DRAWINGS

FIG. 1 is a flow chart diagram illustrating a process for coating a layer of transparent paint on surface of titanium substrate according to the invention; and

FIG. 2 is a sequence of schematic diagrams illustrating the process of FIG. 1.

### DETAILED DESCRIPTION OF THE PREFERRED EMBODIMENTS

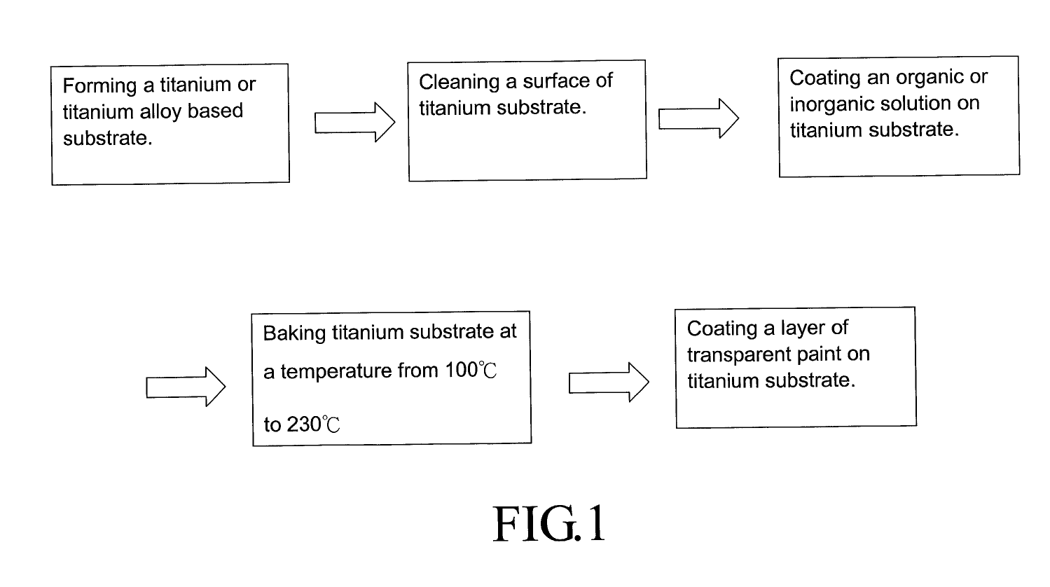

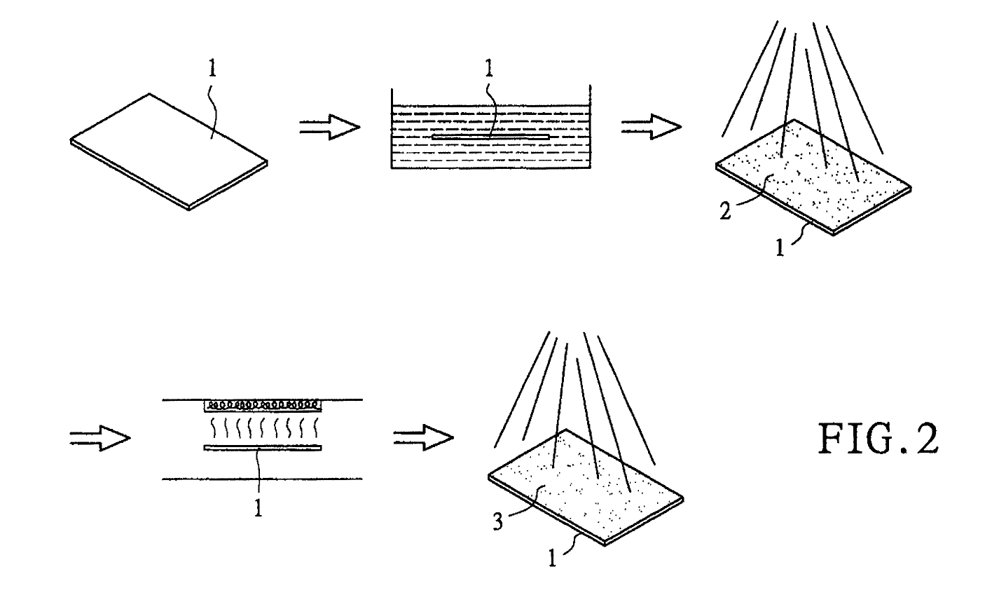

Referring to FIGS. 1 and 2, there is illustrated a process in accordance with the invention comprising (a) forming a titanium or titanium alloy based substrate 1; (b) cleaning a surface of the titanium substrate 1; and (c) uniformly coating an organic or inorganic solution 2 on the surface of the titanium substrate 1 by plating, spraying, or rolling so as to generate a chemical reaction on the surface of the titanium substrate 1 by the organic or inorganic solution, resulting in a strong adhesion between the surface of the titanium substrate 1 and the organic or inorganic solution 2. Note that there is no need to further clean the titanium substrate 1 which has been coated with the organic or inorganic solution 2. The process further comprises (d) baking the titanium substrate 1 coated with the organic or inorganic solution 2 at a temperature in a range from about 100° C. to 230° C.; and (e) uniformly coating a layer of transparent paint 3 on the surface of the titanium substrate 1. This can form a strong adhesion between the surface of the titanium substrate 1 and the layer of transparent paint 3 while demonstrating a unique surface property of the titanium substrate 1.

While the invention has been described by means of specific embodiments, numerous modifications and variations could be made thereto by those skilled in the art without departing from the scope and spirit of the invention set forth in the claims

What is claimed is:

1. A method of forming a coated titanium substrate comprising:
(a) forming a titanium or titanium alloy based substrate;
(b) cleaning a surface of the titanium substrate;
(c) uniformly coating an organic or inorganic solution on the surface of the titanium substrate for forming a strong adhesion between the titanium substrate and the organic or the inorganic solution;
(d) baking the titanium substrate coated with the organic or the inorganic solution at a temperature in a range from about 100° C. to about 230° C.; and
(e) uniformly coating a layer of transparent paint on the surface of the titanium substrate.

2. The method of claim 1, wherein the coating of (b) is done by plating, spraying, or rolling.
